(19) United States
(12) Patent Application Publication
(10) Pub. No.: US 2023/0060941 A1
(43) Pub. Date: Mar. 2, 2023

(54) METHOD FOR GENERATING A TOOL PATH AS WELL AS METHOD AND APPARATUS FOR ADDITIVE MANUFACTURING OF A WORKPIECE USING SUCH A TOOL PATH

(71) Applicant: OPEN MIND Technologies AG, Wessling (DE)

(72) Inventors: Josef KOCH, München (DE); David BOURDAGES, Victoriaville (CA)

(73) Assignee: OPEN MIND Technologies AG, Wessling (DE)

(21) Appl. No.: 17/799,228

(22) PCT Filed: Feb. 5, 2021
(86) PCT No.: PCT/EP2021/052768

§ 371 Date: Aug. 11, 2022

(30) Foreign Application Priority Data
Feb. 11, 2020 (DE) 10 2020 000 880.1

(51) Int. Cl. B29C 64/393; B22F 10/25; B22F 10/366; B22F 10/80; B22F 5/10; G05B 19/4099; B22F 10/38; B29C 64/153

(52) U.S. Cl. CPC B29C 64/393; B22F 10/25; B22F 10/366; B22F 10/80; B22F 5/106; G05B 19/4099; B22F 10/38; B29C 64/153; B33Y 50/02

(57) ABSTRACT

The present invention relates to a method for generating a tool path (20; 82) for an application tool (12) for additive manufacturing, in particular for additive manufacturing using buildup welding, of a substantially rotationally symmetric workpiece (28; 328), comprising the following steps:
a) providing cross-sectional contour data describing at least a portion of a cross-sectional contour (42; 342; 442; 542) of the workpiece (28; 328);
b) providing axis data describing a rotation axis (R) of the rotationally symmetric workpiece (28; 328);
c) generating a continuous cross-sectional path (54; 354; 355; 454; 554), taking into account the cross-sectional contour data, the cross-sectional path (54; 354; 355; 454; 554) being inscribed in the portion of the cross-sectional contour (42; 342; 442; 542);
d) generating the tool path (20; 82) with a helical or/and spiral course revolving around the rotation axis (R), wherein the tool path (20; 82) intersects the cross-sectional path (54; 354; 355; 454; 554), preferably with each revolution around the rotation axis (R).

The present invention relates to a method for generating a tool path and to a method and apparatus for additive manufacturing of a workpiece using such a tool path.

A variety of methods are known for additive manufacturing of workpieces using buildup welding. For example, buildup welding processes are known under the terms of cladding, laser metal deposition, direct energy deposition, direct metal deposition, laser cladding and laser engineered net shaping. Such buildup welding processes are based on 3 or 5-axis control, whereby an application tool performs a relative movement with respect to a workpiece carrier or a workpiece to be manufactured on the workpiece carrier.

All of the methods for buildup welding have in common that a tool path must be specified on which the 3 or 5-axis control is based. According to a prior art procedure, it is known to build a workpiece to be manufactured from a plurality of two-dimensional layers of predetermined height. The individual layers are manufactured one after the other, with material being applied along a generated tool path in the individual two-dimensional layers. A 3D model of a workpiece that is completely divided into the two-dimensional layers may serve as a basis. For each layer, a respective spatial tool path is created to produce the layer. Such methods are comparatively slow, however, because the individual layers must be produced one after the other. Further, it is time-consuming to create tool paths for the plurality of layers.

In order to manufacture rotationally symmetric workpieces, it is also known to directly specify and create a helical tool path along which the application tool is to be guided. The helical tool path allows to manufacture a workpiece continuously without having to manufacture individual layers sequentially one after the other. However, it is a disadvantage that only workpieces having a constant wall thickness can be produced. In addition, it is very costly and complex to generate a helical tool path for manufacturing the workpiece in the first place. This is particularly problematic since this step is usually completed on the basis of an operator's manual specification.

It is an object of the present invention to enable simple generation of a tool path for additive manufacturing of a rotationally symmetric workpiece. It is a further object of the present invention to enable the creation of a tool path from data available on a rotationally symmetric workpiece to be manufactured. In addition, it should be possible to manufacture workpieces of varying wall thickness using the generated tool path. Furthermore, it is an object of the present invention to enable additive manufacturing of a workpiece in a simple manner using a tool path.

The object according to the invention is accomplished by a method for generating a tool path with the features of claim 1. Furthermore, the object according to the invention is accomplished by a method for additive manufacturing of a workpiece using a tool path according to claim 22. The object according to the invention is further accomplished by an apparatus for additive manufacturing of a workpiece using a tool path according to claim 26. Favorable embodiments of the invention are described in the subclaims.

According to claim 1, the above-mentioned object is accomplished by a method for generating a tool path for an application tool for additive manufacturing of a substantially rotationally symmetric workpiece. Additive manufacturing relates in particular to additive manufacturing by buildup welding. The method comprises the following steps:

providing cross-sectional contour data describing at least a portion of a cross-sectional contour of the workpiece;

providing axis data describing a rotation axis of the rotationally symmetric workpiece;

generating a continuous cross-sectional path, taking into account the cross-sectional contour data, the cross-sectional path being inscribed in the portion of the cross-sectional contour;

generating the tool path with a helical or/and spiral course revolving around the rotation axis, wherein the tool path intersects the cross-sectional path, preferably with each revolution around the rotation axis.

The method according to the invention enables the simple generation of a tool path. In particular, this is achieved because only cross-sectional contour data and axis data need to be provided. The cross-sectional contour data describe at least a portion of a cross-sectional contour of the workpiece. This allows to divide a workpiece to be manufactured into different portions, for each of which a tool path is generated. Subdividing into portions is a particular advantage in complex components. A cross-sectional contour of a workpiece is usually a cross-sectional half-contour since in the case of a rotationally symmetric workpiece a cross-sectional half-contour is sufficient to describe the workpiece together with the rotation axis.

Furthermore, the method according to the invention enables the generation of tool paths for an application tool for additive manufacturing of a workpiece having variable wall thickness. This is achieved by the generated tool path running around the rotation axis in a helical or spiral fashion or a combination thereof. A helical course is understood to mean a course in which the tool path revolves around the rotation axis at a constant distance, thereby developing pitch toward the rotation axis. Preferably, pitch is constant. However, pitch may vary at least in sections. Pitch may vary within a revolution and/or between revolutions. A spiral course is understood to mean a course in which the tool path revolves around the rotation axis in a plane, thereby moving away from or toward the rotation axis. This may involve a constant spiral pitch toward the rotation axis or a spiral pitch that varies at least in sections. Spiral pitch may vary within a revolution about the rotation axis and/or between revolutions about the rotation axis. The combination of a spiral and helical course relates to a course in which the tool path revolves around the rotation axis at varying distance while developing a pitch toward the rotation axis. Such a course of the tool path may be an advantage when the wall thickness is comparatively thin and/or when workpiece areas run diagonally and/or between spiral sections of the tool path. If the wall thickness is comparatively thick, the tool path may be spiral at least in sections.

Overall, the method according to the invention is very flexible with regard to the workpieces to be manufactured. Also, it takes no more than a few steps to generate the tool path. Furthermore, cross-sectional contour data and axis data of a workpiece may be easily provided.

According to an embodiment of the invention, step d) may comprise the following sub-steps:

d1) determining tool path points on the cross-sectional path, taking into account at least one manufacturing parameter; and

d2) generating the tool path from tool path sections, wherein each tool path section rotates completely about the rotation axis and connects two adjacent tool path points on the cross-sectional path to one another.

Determining the tool path points on the cross-sectional path enables the definition of points of the cross-sectional path between which the tool path rotates completely around the rotation axis with a tool path section. This makes it possible to easily take into account manufacturing parameters when generating the tool path by means of which the workpiece is to be manufactured using additive manufacturing. Furthermore, the generation of the tool path may be matched with manufacturing parameters or specific additive manufacturing processes. Overall, this may help to increase the flexibility of the method.

Furthermore, the tool path sections between the adjacent tool path points mean that the tool path may be generated individually for the individual tool path sections. This makes it possible to generate a tool path that takes special account of the geometry and contour of the workpiece to be manufactured.

According to an aspect, at least a width or/and a height of a one-time material application by the application tool may be provided as manufacturing parameter(s). This ensures that the generated tool path is matched with manufacturing parameters of specific additive manufacturing processes. In addition, the quality of a workpiece generated using the tool path may be increased. The tool path rotates around the rotation axis in such a way that sufficient material application is ensured for each revolution and at each point of the tool path.

According to an embodiment of the invention, it may further be provided that at least one manufacturing parameter is taken into account when generating the continuous cross-sectional path, wherein at least a width or/and a height of a one-time material application by the application tool is/are provided as manufacturing parameter(s). This may make it easier to suitably inscribe the cross-sectional path to the portion of the cross-sectional contour. Furthermore, it may be ensured that the generated cross-sectional path, and thus the generated tool path, is matched with manufacturing parameters of specific additive manufacturing processes. In addition, the quality of a workpiece generated using the tool path may thus be increased.

According to an aspect of the invention, the cross-sectional path may be inscribed in the portion of the cross-sectional contour such that, as a result of continuous material application along the tool path, taking into account the at least one manufacturing parameter, the portion of the cross-sectional contour is substantially completely filled with material. This may help to increase the quality of a workpiece manufactured using the generated tool path.

According to an embodiment of the invention, it may be provided that the cross-sectional path is formed to be meandering or/and run parallel at least in sections. This applies in particular if the width of the material applied is smaller than a width or wall thickness of the portion of the cross-sectional contour. This helps to achieve sufficient material application. This also helps to achieve sufficient material application when the wall thickness of the workpiece to be manufactured varies. For example, the width of the material applied may be determined based on the minimum wall thickness of the workpiece to be manufactured. In areas where wall thickness is greater than the width of the material applied, the cross-sectional path is meandering or runs parallel at least in sections. For example, if wall thickness is only slightly greater than the minimum wall thickness, the cross-sectional path may be meandering. Thus, the cross-sectional path may cover the entire cross-sectional contour or the entire portion of the cross-sectional contour. On the other hand, if wall thickness is significantly greater than the minimum wall thickness or the width of the material applied, the cross-sectional path may run parallel at least in sections. Parallel portions may, for example, be oriented perpendicular or parallel with respect to the rotation axis. Other orientations of the parallel portions, for instance, angled with respect to the rotation axis, may be provided. A respective parallel portion may be configured such that the respective parallel portion extends from one side of the cross-sectional contour to an opposite side of the cross-sectional contour. Then, the cross-sectional path extends to another parallel portion where it again extends between both sides of the cross-sectional contour. In this way, the total wall thickness can be covered by the cross-sectional path.

In accordance with an aspect of the invention, it may be provided that the cross-sectional path comprises a starting point and an end point each located at an outer or inner edge of the portion of the cross-sectional contour. This may facilitate manufacturing of the workpiece. With reference to the tool path, this helps to achieve that the application tool can approach the starting point and also the end point. Furthermore, this may be used to specify a direction of travel for the application tool through the portion of the cross-sectional contour. In addition, it can be ensured that several portions to be manufactured or respective cross-sectional paths are coordinated with each other.

According to an embodiment of the invention, a course of the cross-sectional path with respect to the rotation axis is taken into account when determining tool path points on the cross-sectional path. For example, it may be taken into account if the cross-sectional path runs parallel, perpendicular or in a combination thereof with respect to the rotation axis. Depending on this, a distance between adjacent tool path points on the cross-sectional path may be chosen. If, for example, the cross-sectional path runs parallel with respect to the rotation axis, a distance between adjacent tool path points on the cross-sectional path may be smaller or larger compared to a perpendicular course. The distance is smaller, for example, when the height is less than the width of the material applied. The reverse case, in which the distance between adjacent tool path points on the cross-sectional path is greater with a parallel course relative to the rotation axis than with a perpendicular course, may apply in particular when the height is greater than the width of the material applied.

According to an embodiment, it may be provided that the tool path points are determined with a substantially constant distance to each other or with at least a first and a second distance on the cross-sectional path. A constant distanced may provide a simple way of determining tool path points on the cross-sectional path. Determining tool path points in such a way may be a particular advantage when the height and width of the material applied are the same. A first distance and a second distance that are different may be used to arrange tool path points on path sections of the cross-sectional path that are aligned differently with respect to each other or path sections with different slopes with respect to the rotation axis. This may be a particular advantage when the height and width of the material applied are different. The first distance may be used to arrange tool path points along a first path section, for example along a horizontally extending path section, on the cross-sectional path. The second distance may be used to arrange the tool path points along a second, in particular differently oriented, path section. To determine a tool path point, a combination of at least two distances may be used for path sections of the cross-sectional path having at least one transition between differently oriented path sections.

According to an aspect of the invention, it may be provided that each tool path section between adjacent tool path points of the cross-sectional path is determined in accordance with a course of the cross-sectional path section lying between these adjacent tool path points. This helps to achieve that the course of the cross-sectional path or the cross-sectional path sections directly determines the course of the tool path. If the cross-sectional path is inscribed in the portion of the cross-sectional contour, in particular taking into account the manufacturing parameters, it may be achieved that the generated tool path is inscribed in the workpiece to be manufactured.

According to an embodiment, the tool path section between the adjacent tool path points may be generated by taking at least one item of position information into account starting from a first of the adjacent tool path points until reaching the second of the adjacent tool path points. The at least one item of position information relates in particular to information of a point on the cross-sectional path. Thus, the course of the cross-sectional path from the first of the adjacent tool path points until reaching the second of the adjacent tool path points may directly affect the course of the tool path or the tool path section.

According to an aspect of the invention, the position information may comprise:

a height coordinate of a point on the cross-sectional path or/and

a distance coordinate of a point on the cross-sectional path relative to the rotation axis or and

angle information with respect to the first or/and second tool path point.

The tool path section between the adjacent tool path points may be generated in particular by taking into account the position information for at least one point or even all points starting from the first of the adjacent tool path points until the second of the adjacent tool path points is reached and assigning the position information to a corresponding point or the corresponding points of the tool path section.

The angle information for a point on the tool path may depend on how much progress is made on the cross-sectional path, starting from the first of the adjacent tool path points until reaching the second of the adjacent tool path points. For example, the angle information may be 0° for the first of the adjacent tool path points and 360° for the second of the adjacent tool path points. Depending on how much progress is made on the cross-sectional path, a fraction of 360° is determined as the angle information. In this way, a complete rotation of the tool path between adjacent tool path points can be achieved.

According to an embodiment of the invention, the method may further comprise the step of providing alignment information for at least one point of the tool path, preferably for at least one of the tool path points. The alignment information describes an alignment of a tool axis of the application tool in the point of the tool path or the tool path point. The alignment information may be different or variable for points of the tool path or for tool path points. This helps to achieve a high quality of a workpiece to be manufactured using the tool path. This further allows to better take into account the course of the cross-sectional contour of the workpiece. This improves the manufacture of workpieces with special features or more complex contours. In particular, it facilitates the manufacture of overhangs.

According to an embodiment of the invention, it may be provided that the alignment information for at least one further point of the tool path, in particular another one of the tool path points, is determined taking into account the alignment information for the at least one point of the tool path, in particular the at least one of the tool path points. This enables the use of the alignment information for the at least one point of the tool path to determine alignment information for the at least one further point of the tool path. This reduces the number of points of the tool path or tool path points for which the alignment information is specified. At the same time, further points of the tool path receive alignment information. While the effort for providing alignment information is small, the quality of a workpiece to be manufactured is high. The alignment information for the at least one further point of the tool path may be determined, for example, by rotating about the rotation axis. If two items of alignment information are provided, the alignment information for the at least one further point of the tool path or tool path point may also be averaged or determined using interpolation and, in particular, linear interpolation.

According to an aspect of the invention, it may be provided that the alignment information is provided for a first and a second point of the tool path, preferably for a first and a second tool path point, respectively, and that a continuous course is determined for points between the first and the second point on the tool path, preferably between the first and the second tool path point. The continuous course of the alignment information may be averaged or determined using interpolation and, in particular, linear interpolation. Furthermore, the continuous course of the alignment information along the tool path may be determined by rotating around the rotation axis. This reduces the number of points of the tool path or the tool path points for which the alignment information is specified. At the same time, further points of the tool path also receive alignment information.

According to an embodiment of the invention, it may be provided that (i) a first item of alignment information is provided for at least one point on the cross-sectional path; and (ii) a second item of alignment information is provided for at least one point on the tool path, preferably for at least one of the tool path points, based on the first item of alignment information; wherein each item of alignment information describes an alignment of a tool axis of the application tool for the respective point. Alignment information may therefore be available in conjunction with the cross-sectional path, and based thereon, alignment information may then be provided for a point of the tool path or a tool path point. This may facilitate the provision of alignment information for the tool path. A second item of alignment information may be provided, for example, by rotating the first item of alignment information around the rotation axis.

According to a further embodiment of the invention, it may be provided that the first item of alignment information for at least one further point on the cross-sectional path is determined taking into account the first item of alignment information. This reduces the number of points of the cross-sectional path for which the alignment information is specified. At the same time, further points of the cross-sectional path also receive alignment information. The first item of alignment information for the at least one further point may be transmitted unchanged. Alternatively, if two first items of alignment information are provided, the first item of alignment information for the at least one further point may be averaged or determined using interpolation and, in particular, linear interpolation.

According to a further embodiment of the invention, the first item of alignment information is provided in step (i) for a first and a second point on the cross-sectional path, respectively, and a continuous course is determined for points between the first and the second point on the cross-sectional path. The continuous course of the alignment information may be averaged or determined using interpolation and, in particular, using linear interpolation. This reduces the number of points of the cross-sectional path for which the first item of alignment information is specified. At the same time, further points of the cross-sectional path and thus of the tool path receive alignment information.

According to an aspect of the invention, the alignment information describes an angle between the tool axis and the rotation axis or a direction vector in the direction of the tool axis. Preferably, the direction vector points in the direction of the tool.

According to an embodiment, the alignment information of a point on the tool path, preferably a tool path point, or a point of the cross-sectional path is determined on the basis of a course of the cross-sectional contour. In this way, reliable material application along the tool path may be achieved. Furthermore, this may improve the manufacture of varying wall thickness of the workpiece to be manufactured. In particular, overhangs of the workpiece may be manufactured more effectively.

According to an aspect of the invention, the cross-sectional contour data or/and axis data are determined from: 3D model data of the workpiece, or data of a preferably two-dimensional removal tool path for a removal tool of a cutting process for manufacturing the workpiece, preferably of a machining process, particularly preferably of a turning or/and milling process.

This makes it possible to easily provide the cross-sectional contour data or the axis data. Frequently, 3D model data or data of an removal tool path of a workpiece to be manufactured are already available, which may then be used to advantage. The 3D model data may be common 3D model data such as a CAD data set or a surface model or a mesh. Such procedure may facilitate the automated generation of the tool path.

In the case of removal tool path data, the removal tool path may serve as an outer and/or inner boundary up to which additive material is required to be applied. According to an aspect, the removal tool path data provide the cross-sectional contour data and/or the axis data, and the continuous cross-sectional path is inscribed in the removal tool path. According to a further aspect, the removal tool path may provide a cross-sectional path.

The task according to the invention is further accomplished by a method for additive manufacturing of a workpiece using at least one tool path generated according to a method as explained above. This facilitates additive manufacturing of a workpiece.

According to an aspect of this manufacturing method, at least one of the following manufacturing parameters may be variable during additive manufacturing of the workpiece:

Composition of the additive manufacturing material,

Feed rate of the application tool,

Power of the application tool, and

Gas flow of the application tool.

The additive manufacturing material may be a powder material whose composition may be changed during the manufacturing process, for example along the tool path. The proportions of different material components of the powder material may be changed for a varying overall composition of the powder material. Similarly, the feed rate of the application tool may be changed as it moves down the tool path, for example, to achieve a varying thickness of material applied at the same application rate (supplied quantity per time) of the additive manufacturing material. Additionally or alternatively, the power of the application tool may be changed along the tool path, for example, the power of an application laser or the power of another energy source. Additionally or alternatively, the gas flow through a nozzle of the application tool may be changed along the tool path to change the properties of the material applied along the tool path or cross-sectional path depending on the location. The respective parameter changes may be made dynamically through NC instructions, wherein such instructions may be set in the manufacturing program.

The individual manufacturing parameters may be defined directly for individual points along the cross-sectional path or along the tool path and then be communicated to the application tool.

In an embodiment of the method, different parameter values may be assigned to at least one of the manufacturing parameters at different points along the cross-sectional path or along the tool path. In other words, the specific manufacturing parameter may have different amounts at the individual points along the cross-sectional path or along the tool path. This helps to achieve different properties in certain areas of the workpiece.

In this context, according to an embodiment of the method according to the invention, the parameter values of a specific manufacturing parameter in a portion of the cross-sectional path or tool path between two successive points at which the manufacturing parameter has different parameter values are determined by interpolation, preferably by linear interpolation. By way of example, this means that the relevant manufacturing parameter has a first value at one point on the cross-sectional path or tool path and a second value that differs by an amount at a subsequent second point. Between these two points, the values for this manufacturing parameter are determined by linear or some other type of interpolation in order to achieve smooth or abrupt transitions in the material properties of the workpiece. This helps to achieve gradient materials, i.e. components whose material composition and hence their mechanical properties change along their course.

According to an embodiment of the method according to the invention, the manufacturing parameter of the composition of the additive manufacturing material, preferably of an additive manufacturing powder, is changed dynamically along the cross-sectional path. Such change in the composition of the additive manufacturing material, in particular of the powder material, may be accompanied by a change in other manufacturing parameters, in particular the feed rate and/or the laser power and/or the gas flow in the nozzle of the application tool.

An embodiment of the manufacturing method according to the invention further takes into account the time delay when feeding the material until the workpiece is reached. In this context, it must be taken into account that in the case the material composition is changed in the position where different materials are mixed, a certain amount of time passes until the materials are ejected by the nozzle and the changed additive manufacturing material reaches the workpiece. This means that there is a time delay between the activation of the containers containing the different material components and their mixing through corresponding parameter changes in assigned NC instructions on the one hand and the material being ejected or reaching the component on the other hand. Such time delay must be taken into account in the manufacturing process and implemented in assigned NC programs. This ensures that the desired material composition reaches the respective intended point on the cross-sectional path or the tool path for manufacturing the workpiece.

Further, it should be noted that according to the method according to the invention, the respective manufacturing parameters can be directly assigned to individual points of the cross-sectional path or of the tool path, in a similar way as described above with reference to the angle information.

According to an aspect, it may be provided that moving along the tool path is performed at a substantially constant feed rate for the application tool. This may mean that moving along the tool path is performed at a constant feed rate at least in sections. A constant feed rate is a particular advantage if a uniform material application is desired. This is especially the case if material feed is constant.

According to an embodiment of the invention, moving along the tool path may further be performed at a variable feed rate for the application tool. This may mean that moving along the tool path is performed at a variable feed rate at least in sections. A variable feed rate is a particular advantage if a varying material application is desired.

According to a further embodiment of the invention, the tool feed rate is increased or decreased compared to a preceding tool revolution at least during a final tool revolution. A final revolution relates to both a first and an actually final revolution of the tool path. During a first revolution, it may be an advantage to start with a high tool feed rate and to decrease it during the first revolution. This helps to achieve a material application that increases with the revolution of the tool path. During a final revolution, it may be an advantage to start with a comparatively low or previously constant tool feed rate and to increase it during the final revolution. This helps to achieve a material application that decreases with the final revolution of the tool path.

Tool feed generally describes the relative movement between the application tool and the workpiece or workpiece base on which the workpiece is manufactured, regardless of whether the application tool or the workpiece or workpiece base is actually moved.

According to an embodiment of the invention, material feed for additive manufacturing may be substantially constant. This helps to achieve a uniform material application during additive manufacturing of the workpiece. This is particularly true if, as explained above, moving along the tool path is performed at a constant feed rate for the application tool. Alternatively, material feed may be constant or varying at least in sections along the tool path. A varying material feed may be an advantage, for example, during a first or final revolution to supply increasing or decreasing quantities of material.

Furthermore, the task according to the invention will be solved by an apparatus for additive manufacturing of a substantially rotationally symmetric workpiece using a tool path generated with the method described above. The apparatus comprises an application tool for additive manufacturing, in particular a buildup welding head. In accordance with cross-sectional contour data describing at least a portion of a cross-sectional contour of the workpiece, and in accordance with axis data describing a rotation axis of the rotationally symmetric workpiece, the apparatus generates a continuous cross-sectional path taking into account the cross-sectional contour data. The cross-sectional path is inscribed in the portion of the cross-sectional contour. The apparatus generates the tool path with a helical or/and spiral course revolving around the rotation axis. The tool path intersects the cross-sectional path, preferably with each revolution around the rotation axis. The apparatus guides the application tool along the tool path, applying material in the process.

The apparatus according to the invention enables simple additive manufacturing of an essentially rotationally symmetric workpiece. The apparatus according to the invention may further be used to manufacture a workpiece having variable wall thickness. At the same time, the apparatus according to the invention enables a workpiece to be manufactured quickly. It is possible to generate a tool path simply and quickly to then manufacture a workpiece comparatively quickly on the basis of such tool path.

According to an embodiment, the apparatus may further comprise a method for additive manufacturing as described above.

According to an aspect of the invention, the apparatus may be a 3-axis or a 5-axis buildup welding apparatus. In the 5-axis buildup welding apparatus, three axes may be linear axes and two axes may be rotation axes. In the 3-axis buildup welding apparatus, two axes may be linear axes and one axis may be a rotation axis.

According to an embodiment, the apparatus may further comprise at least one workpiece base on which additive manufacturing of the workpiece using the application tool may be performed.

In the following, the present invention is described by way of example with reference to the accompanying figures. In the drawings:

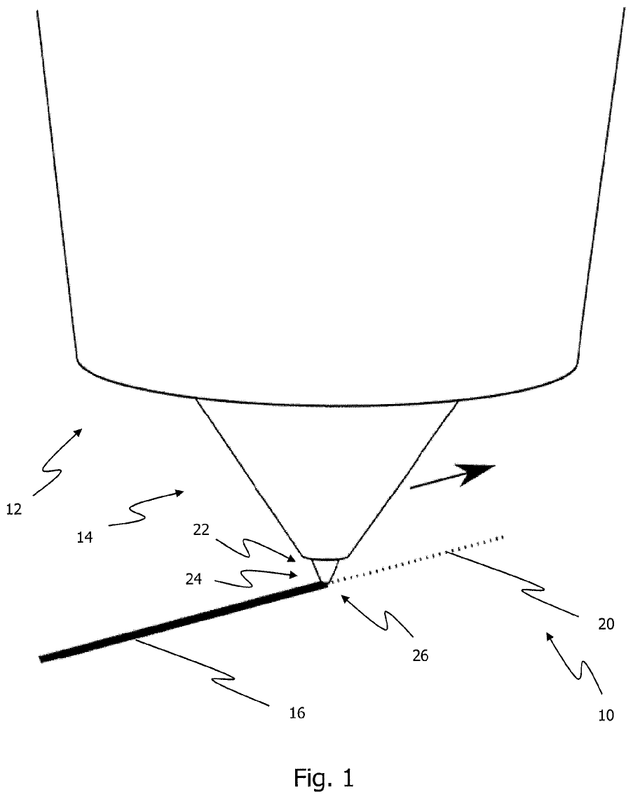

FIG. 1 is a schematic side view of an application tool according to the invention;

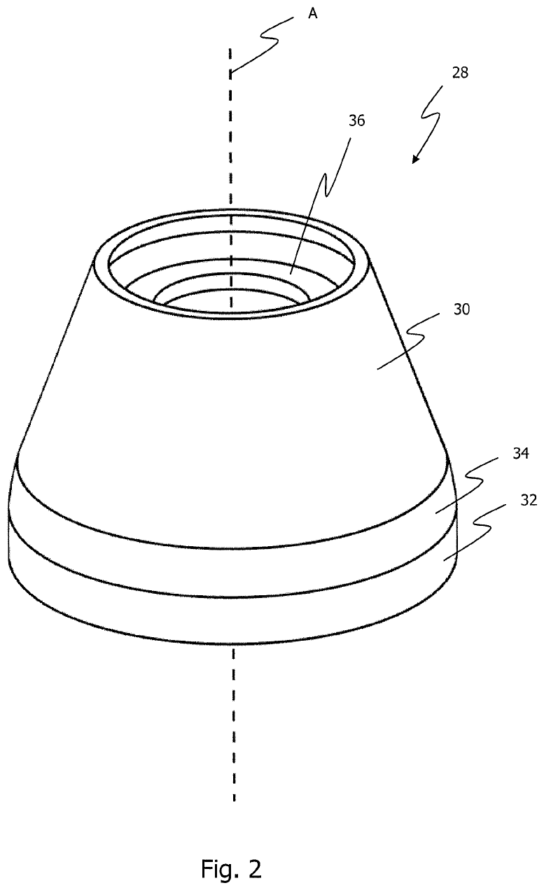

FIG. 2 shows a rotationally symmetric workpiece to be manufactured;

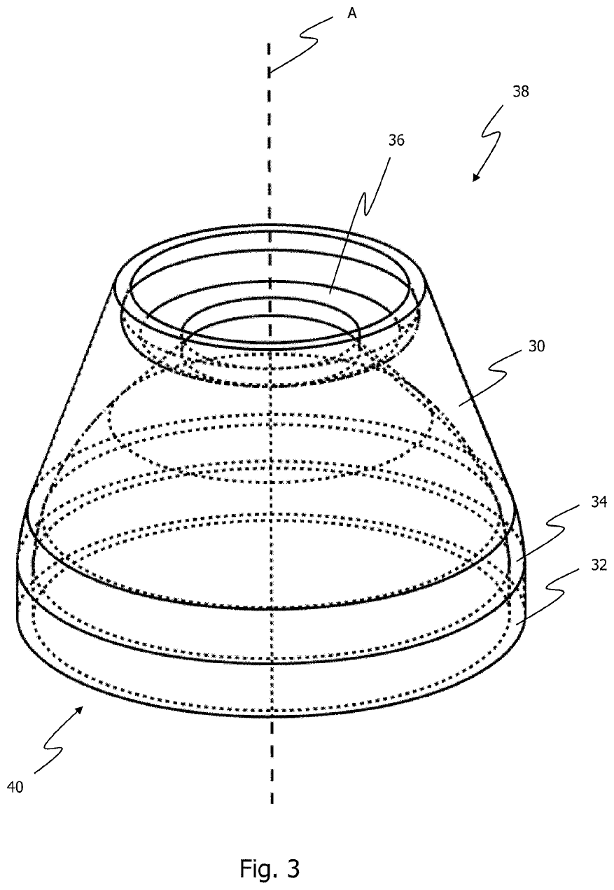

FIG. 3 shows a model of a workpiece to be manufactured;

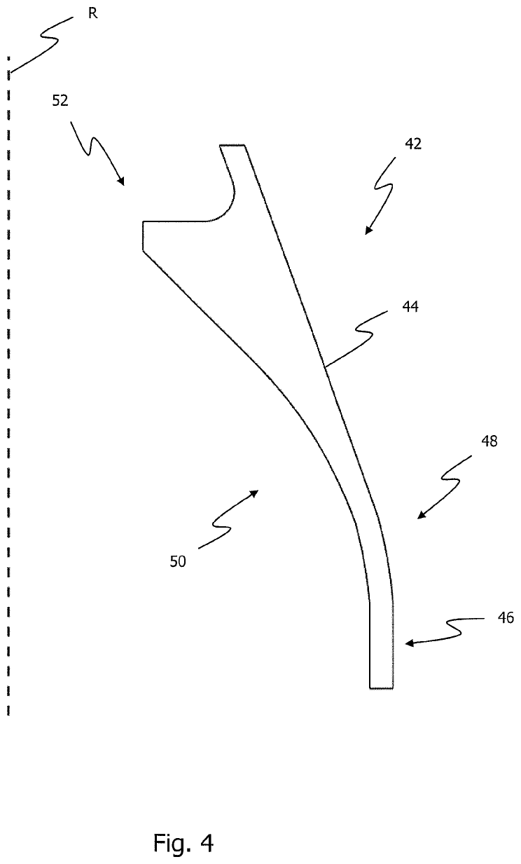

FIG. 4 shows a cross-sectional contour of a workpiece to be manufactured;

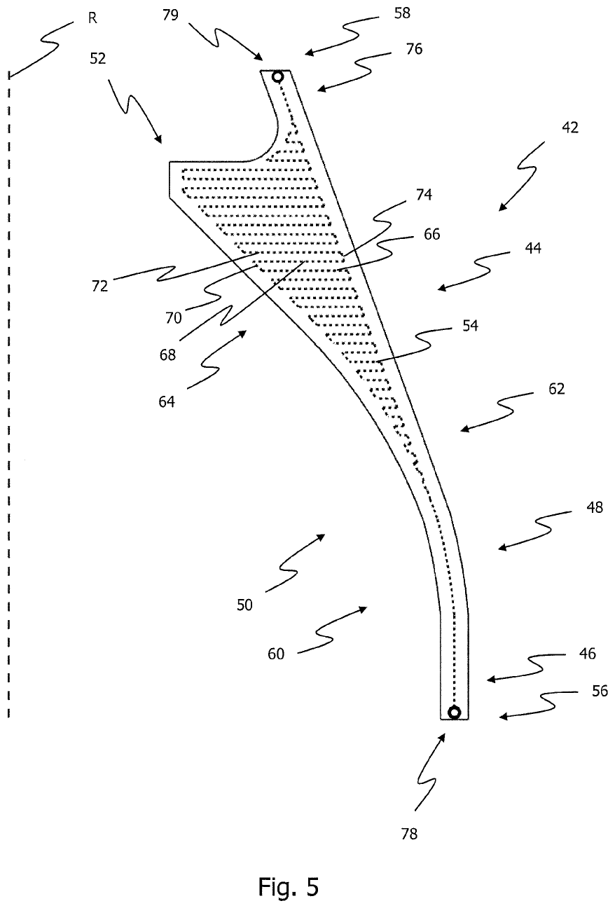

FIG. 5 shows a cross-sectional contour incl. continuous cross-sectional path;

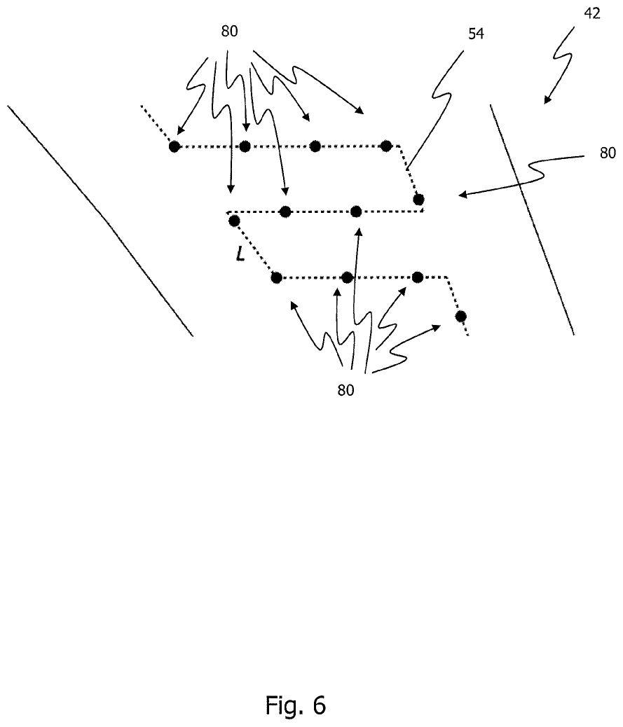

FIG. 6 shows a section of the cross-sectional contour incl. tool path points;

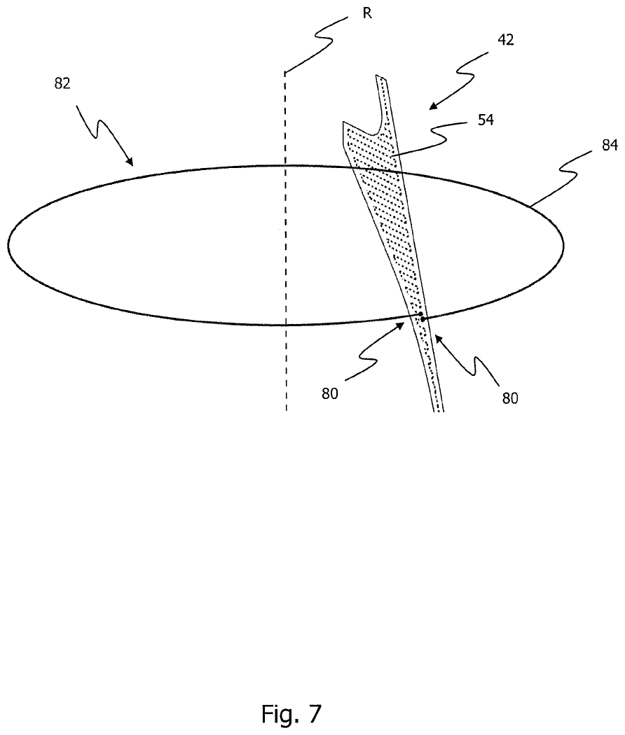

FIG. 7 shows a cross-sectional contour with a continuous cross-sectional path incl. exemplary tool path;

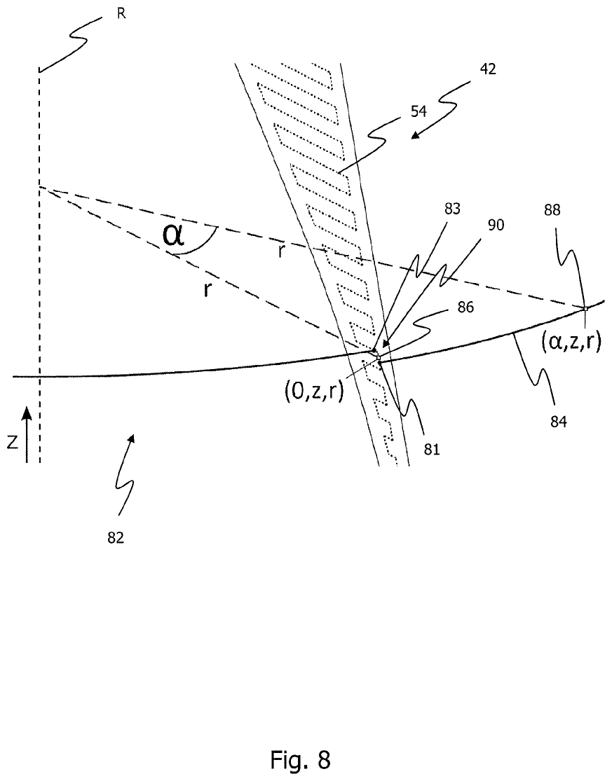

FIG. 8 shows an exemplary tool path in connection with the continuous cross-sectional path;

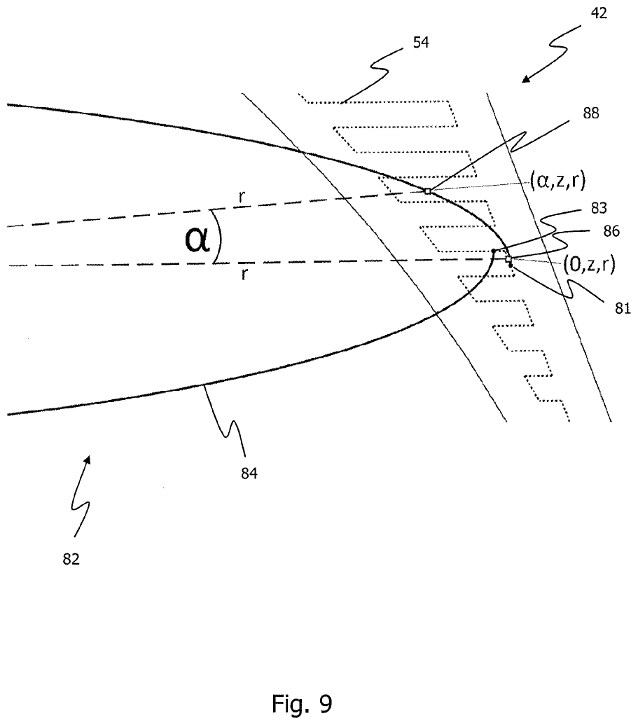

FIG. 9 is an alternative view of the tool path in connection with the continuous cross-sectional path;

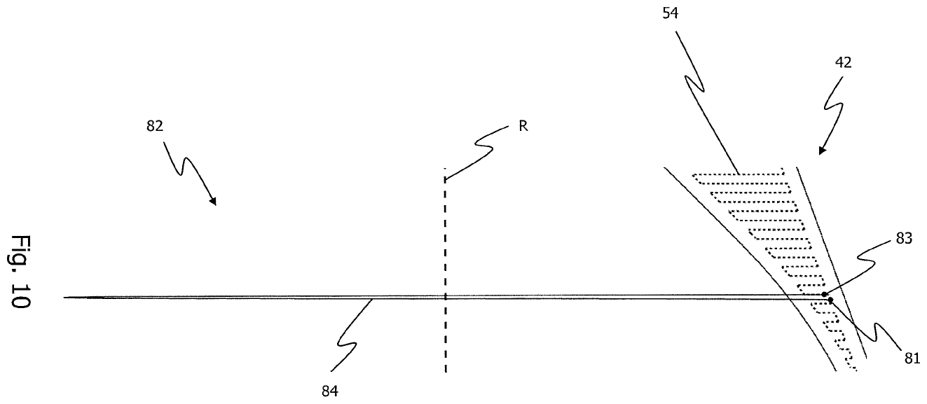

FIG. 10 is another alternative view of the tool path in connection with the continuous cross-sectional path;

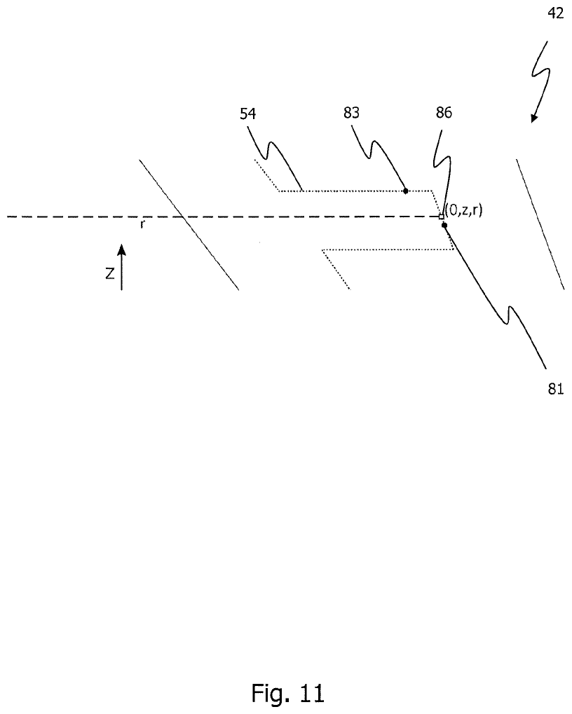

FIG. 11 shows a section of the cross-sectional contour incl. continuous cross-sectional path;

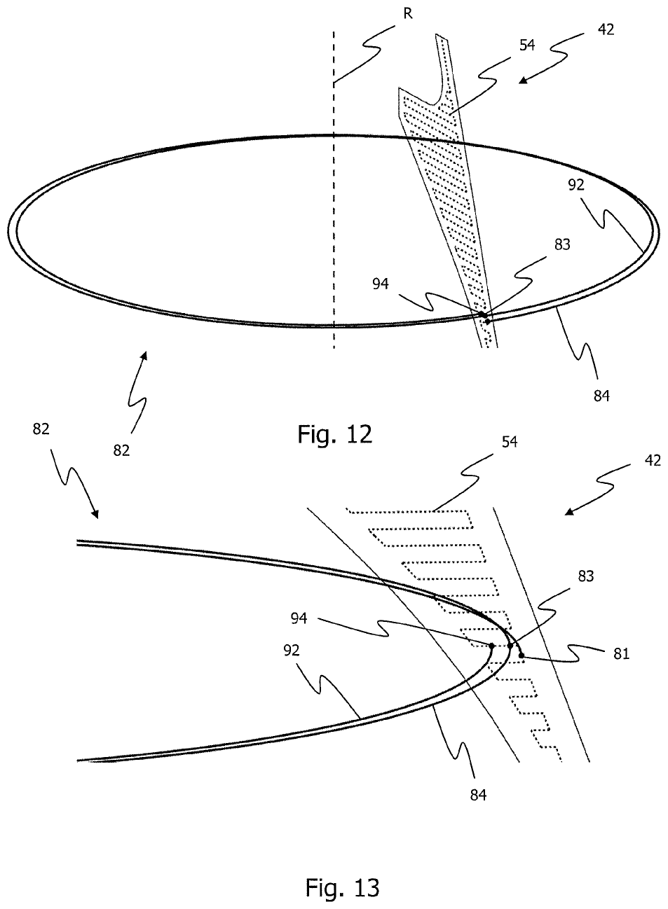

FIG. 12 is a view of an extended tool path;

FIG. 13 is an alternative view of the extended tool path;

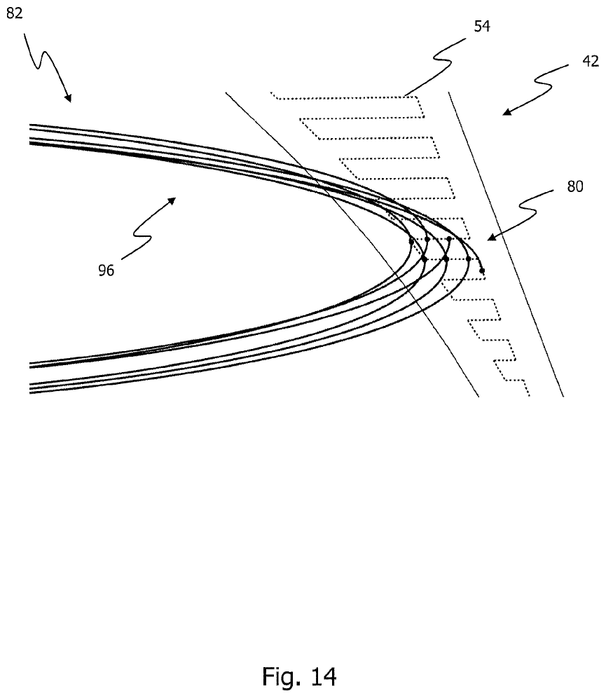

FIG. 14 is a view of an additionally extended tool path;

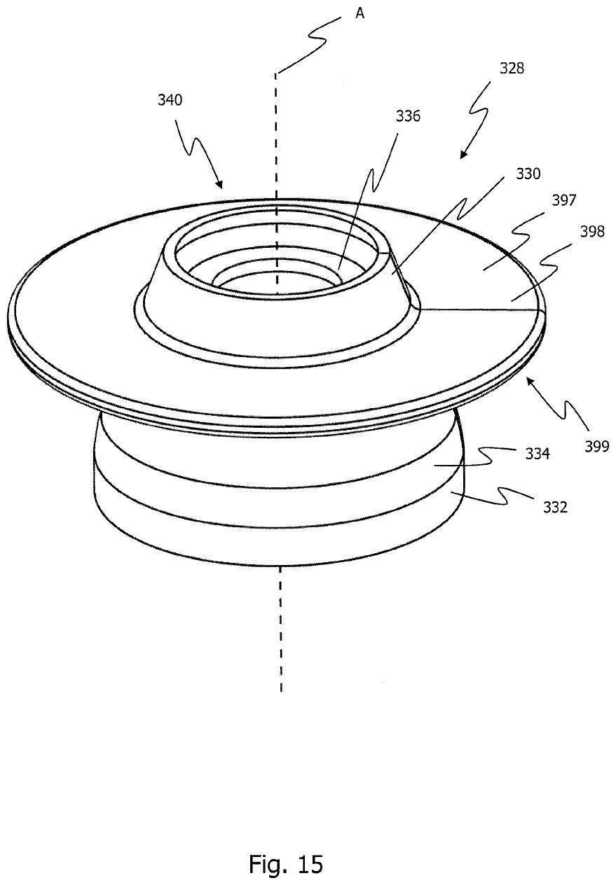

FIG. 15 shows an alternative workpiece to be manufactured;

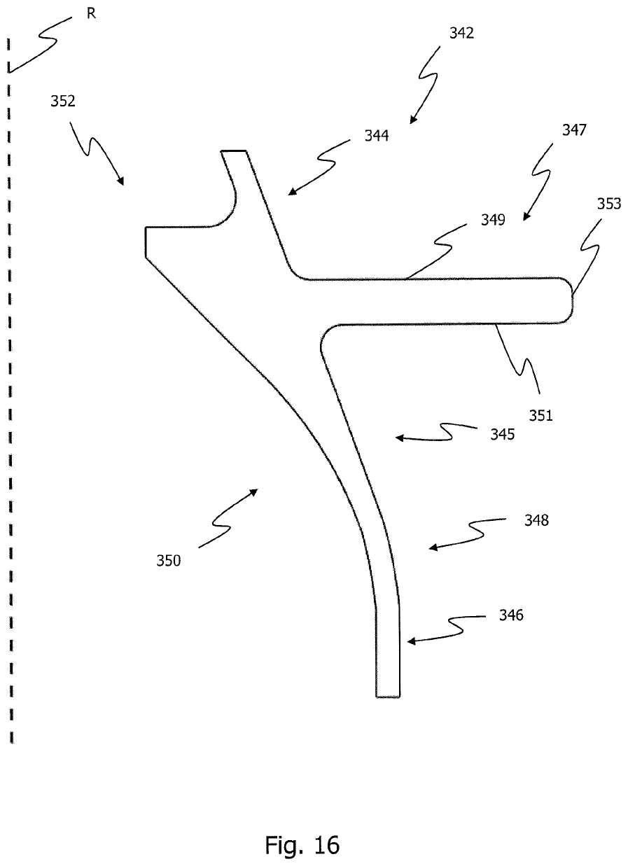

FIG. 16 shows a cross-sectional contour of the alternative workpiece to be manufactured;

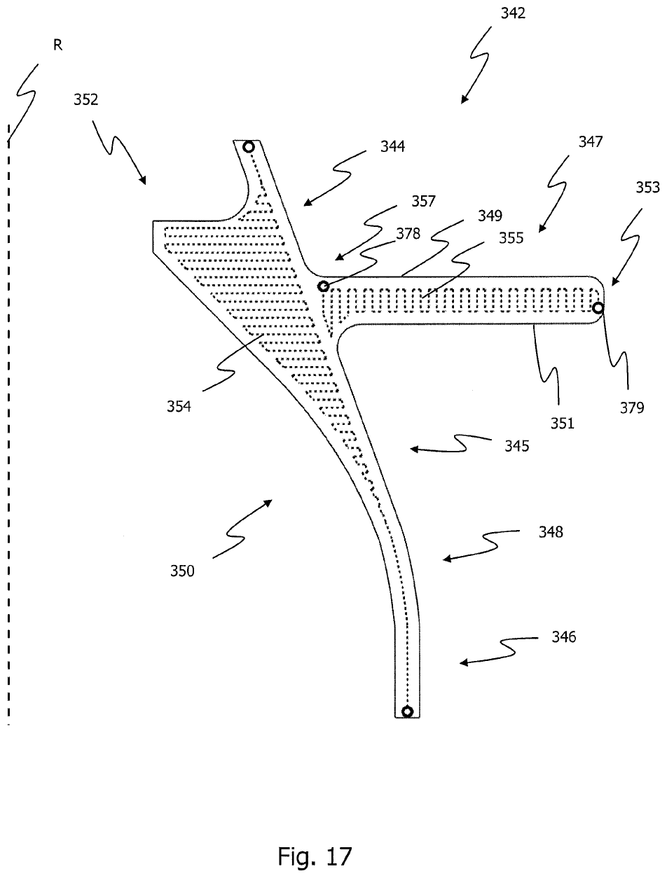

FIG. 17 shows a cross-sectional contour of the alternative workpiece to be manufactured incl. continuous cross-sectional path;

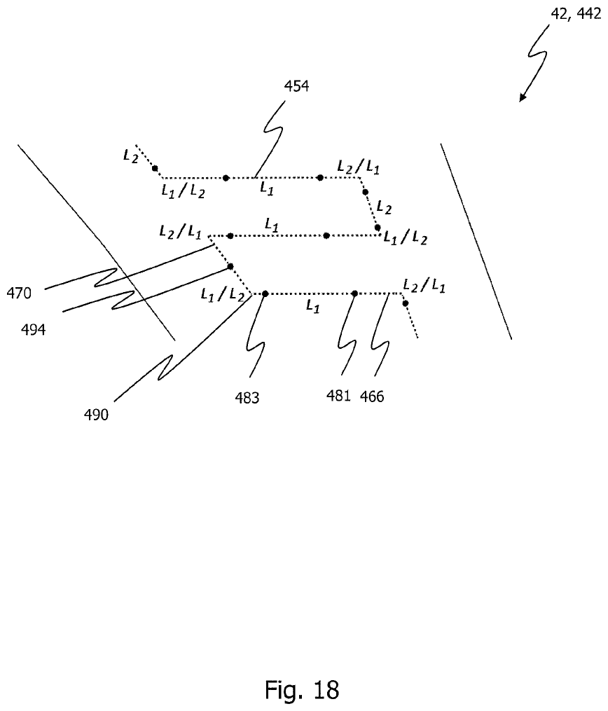

FIG. 18 shows a section of the cross-sectional contour with alternative tool path points;

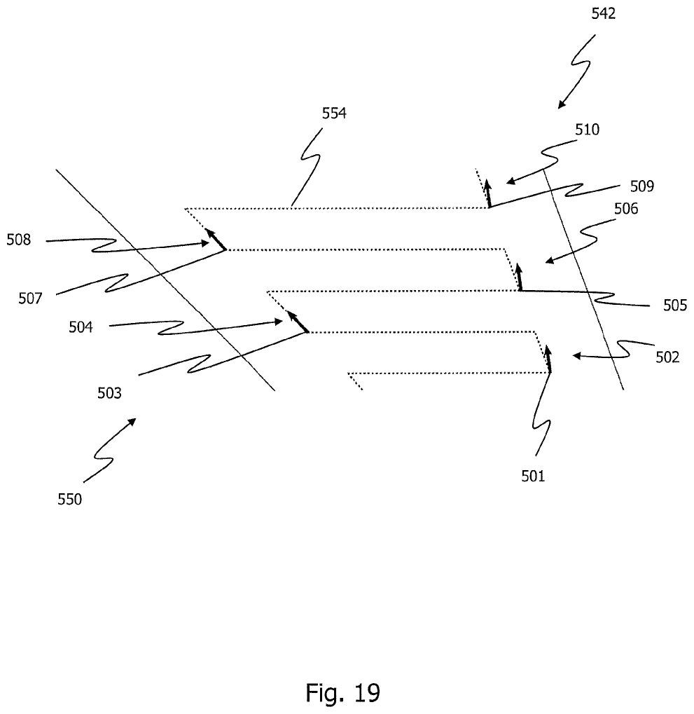

FIG. 19 shows a section of the cross-sectional contour with a continuous cross-sectional path incl. alignment information;

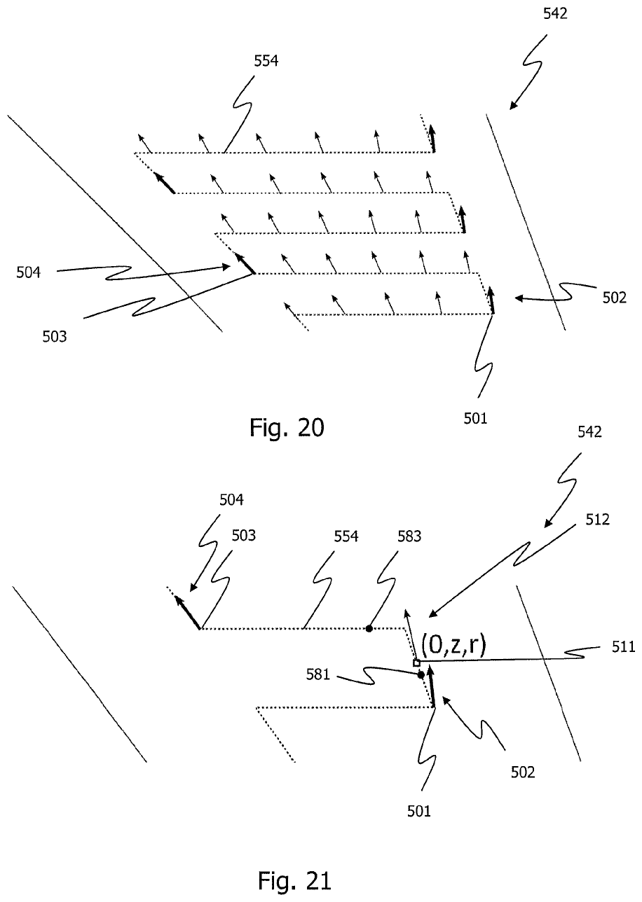

FIG. 20 shows a section of the cross-sectional contour with a continuous cross-sectional path incl. determined alignment information;

FIG. 21 shows a section of the cross-sectional contour with a continuous cross-sectional path incl. determined alignment information for one point; and

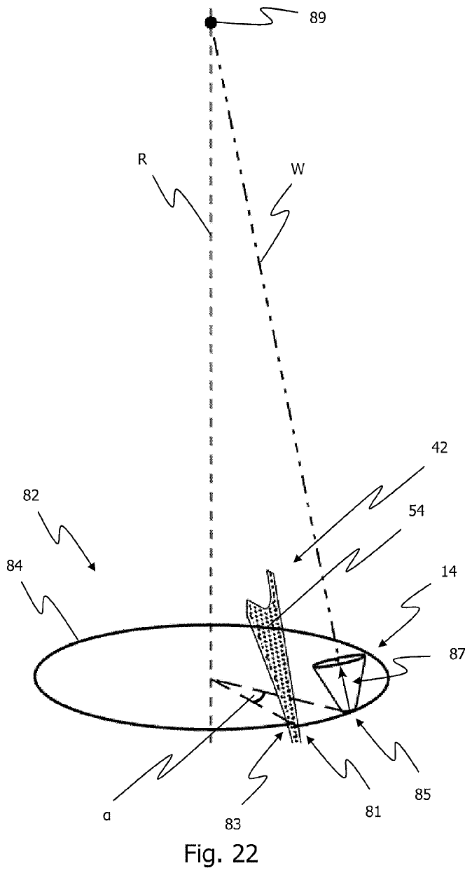

FIG. 22 shows a cross-sectional contour with a continuous cross-sectional path incl. exemplary tool path.

FIG. 1 is a schematic side view of an apparatus 10 according to the invention for additive manufacturing of a substantially rotationally symmetric workpiece. The apparatus 10 comprises an application tool 12 including application tool head 14. The application tool 12 moves relative to a workpiece base (not shown in more detail) onto which a material path 16 is applied along a tool path 20 for additive manufacturing of a workpiece. A laser beam 22 comes out of the application tool head 14 along with powder substance 24. The powder substance 24 could be supplied to the laser beam 22 in other ways, such as laterally. Further, instead of powder substance 24, wire, for example, could be supplied to laser beam 22. The laser beam 22 is directed to a focal point 26 and heats the powder substance 24 or material at this focal point 26 to such an extent that the powder substance 24 melts. In this process, material already applied from another material path or a surrounding substance may be melted and bonded to the melted, former powder substance 24. Outside the focal point 26, cooling takes place and the material path 16 is formed.

FIG. 2 is a perspective side view of an example of a rotationally symmetric workpiece 28 to be manufactured. Due to rotational symmetry, the workpiece 28 has a symmetry axis A. The workpiece 28 is hollow on the inside and comprises a frustoconical lateral surface 30. The workpiece 28 further comprises a cylindrical lateral surface 32 that is connected to the frustoconical lateral surface 30 by a transitional lateral surface 34. An inner shoulder 36 is recognizable on the workpiece 28.

FIG. 3 shows an example of a model 38 in the form of a 3D model of the rotationally symmetric workpiece 28 to be manufactured. The model 38, too, is shown in a perspective side view. Like the workpiece 28, the model has the symmetry axis A. Furthermore, the frustoconical lateral surface 30, the cylindrical lateral surface 32 and the transitional lateral surface 34 are visible. In addition, the inner shoulder 36 is recognizable.

Compared to the workpiece 28 of FIG. 2, the model 38 is a transparent representation of the workpiece 28, in which inner surfaces of the workpiece 28 are recognizable. It can be seen, for example, that on the inside below the shoulder 36, an inner surface 40 is formed that is not parallel to the frustoconical lateral surface 30. Rather, a wall of the workpiece 28 is thicker in the area of the shoulder 36 than a wall in a lower area of the frustoconical lateral surface 30. Wall thickness is constant in the areas of the transitional lateral surface 34 and of the cylindrical lateral surface 32.

FIG. 4 shows a cross-sectional contour 42 of the workpiece 28 to be manufactured together with a rotation axis R, the cross-sectional contour 42 being a closed contour line. The rotation axis R corresponds to the symmetry axis A of FIGS. 1 to 3.

The cross-sectional contour 42 is based on the rotationally symmetric workpiece 28 or model 38. The cross-sectional contour 42 is two-dimensional. It can be generated by intersecting the workpiece 28 or the model 38 with a plane in which the symmetry axis A lies. When the workpiece 28 or the model 38 is intersected in this manner, two cross-sectional half contours are generated that are separated from each other by the symmetry axis A. The cross-sectional contour 42 is one of the two cross-sectional half contours. The cross-sectional contour 42 is spaced from the rotation axis R because the workpiece 28 or model 38 is hollow on the inside. The arrangement of the cross-sectional contour 42 relative to the rotation axis R is the result of the rotationally symmetric workpiece 28 or the model 38 and the previously explained generation of the cross-sectional contour 42.

The cross-sectional contour 42 has an oblique contour line 44 that is based on the frustoconical lateral surface 30. The cross-sectional contour further has a perpendicular contour line 46 that is based on the cylindrical lateral surface 32. The oblique contour line 44 and the perpendicular contour line 46 are connected by an arcuate contour line 48 that is based on the transitional lateral surface 34. The cross-sectional contour 42 further has an inner contour line 50 that is based on the inner surface 40. Further, a shoulder contour line 52 is formed based on the shoulder 36.

It can be seen that the cross-sectional contour 42 together with the rotation axis R describes the rotationally symmetric workpiece 28 or model 38. A contour of the rotationally symmetric workpiece 28 or the model 38 can be generated by rotating the cross-sectional contour 42 about the rotation axis R. In the process, the cross-sectional contour 42 performs a 360° rotation about the rotation axis R.

It can further be seen that the cross-sectional contour 42 represents different wall thicknesses of the workpiece 28 or model 38.

FIG. 5 shows the cross-sectional contour 42 of FIG. 4 including the rotation axis R. However, in contrast to FIG. 4, a continuous cross-sectional path 54 is inscribed in the cross-sectional contour 42. The continuous cross-sectional path 54 starts at a lower end 56 of the cross-sectional contour 42 and extends to an upper end 58 of the cross-sectional contour 42. In particular, at the lower end 56 and the upper end 58, the cross-sectional path 54 is configured such that it contacts the cross-sectional contour 42. In between, the cross-sectional path 54 is spaced from the cross-sectional contour 42.

In a first portion 60 that is disposed at the lower end 56 and in an area of the perpendicular contour line 46 and the arcuate contour line 48, the cross-sectional path 54 is substantially evenly spaced with respect to the perpendicular contour line 46 or the arcuate contour line 48 and the inner contour line 50. In the area of the perpendicular contour line 46, the cross-sectional path 54 is substantially straight. In the area of the arcuate contour line 48, however, the cross-sectional path 54 is arcuate, too.

A second portion 62 of the cross-sectional path 54 is disposed in the areas of the arcuate contour line 48 and of the oblique contour line 44. In the second portion 62, the cross-sectional path 54 is meandering. In particular, the cross-sectional path 54 is meandering between the arcuate contour line 48 or the oblique contour line 44 and the inner contour line 50.

A third portion 64 of the cross-sectional path 54 is disposed in the area of the oblique contour line 44. In the third portion 64, the cross-sectional path 54 runs in paths that are parallel to each other. By way of example, a first path 66 is discussed that is arranged parallel to a second path 68. The first path 66 is connected to the second path 68 by a first connecting path 70. A third path 72 is arranged parallel to the first path 66 and the second path 68 and is connected to the second path 68 by a second connecting path 74. The paths 66, 68, 72 are arranged perpendicular to the rotation axis R. The first connecting path 70 is disposed near the inner contour line 50 and substantially parallel to an adjacent course of the inner contour line 50. The second connecting path 74 is disposed near the oblique contour line 44 and substantially parallel to an adjacent course of the oblique contour line 44. Generally, connecting paths may be parallel to an adjacent course of the cross-sectional contour 42.

It can be seen that the parallel paths, as exemplified by the paths 66, 68, 72, depend on the wall thickness of the cross-sectional contour 42. The greater the wall thickness of the cross-sectional contour 42, the longer the parallel paths.

It can further be seen that the parallel paths are the biggest in the area of the shoulder contour line 52 where the wall thickness of the cross-sectional contour 42 is the greatest.

In a fourth portion 76 above the shoulder contour line 52 and in the area of the upper end 58, the parallel paths of the cross-sectional path 54 become smaller before the cross-sectional path 54 is substantially straight again. Further, the cross-sectional path 54 is configured to contact the cross-sectional contour 42 in the area of the upper end 58.

It should be noted that the cross-sectional path 54 is an example of how the cross-sectional path 54 may be disposed within the cross-sectional contour 42. However, it is essential that the cross-sectional path 54 has a defined starting point 78 and a defined end point 79 that are disposed on the outside of the cross-sectional contour 42 or the outside of a portion of the cross-sectional contour if the cross-sectional contour 42 is divided into several portions. The cross-sectional path 54 may be configured in different ways within the cross-sectional contour 42 between the defined starting point 78 and the defined end point 79.

Furthermore, the cross-sectional path 54 is inscribed in the cross-sectional contour 42 in such a way that material application along a tool path to be generated from the cross-sectional path 54 is sufficient. In this context, it may be an advantage to take manufacturing parameters into account already when generating the continuous cross-sectional path 54. The manufacturing parameters may include a width and a height of the material applied.

According to a simplified procedure, it can be assumed that material is applied along the cross-sectional path 54. The cross-sectional path 54 is to be inscribed in the cross-sectional contour 42 in such a way that the material applied fills the cross-sectional contour 42 completely.

In the present case, it can be seen that apart from the starting point 78 and the end point 79, the cross-sectional path 54 is spaced from the cross-sectional contour 42. This is due to the manufacturing parameters. For example, if the cross-sectional path 54 is substantially parallel to an adjacent portion of the cross-sectional contour 42, as is the case with the first portion 46 or the connecting paths 70, 74, the cross-sectional path 54 may be spaced from the cross-sectional contour 42 by half the width of the material applied in each case.

The parallel paths, too, are generated taking into account manufacturing parameters. As explained by way of example with reference to the first path 66 and the second path 68, they are spaced from one another by a predetermined distance. Preferably, such predetermined distance also results from the manufacturing parameters. For example, the predetermined distance corresponds to a height of the material applied.

FIG. 6 shows a section of the cross-sectional contour 42 of FIG. 5. In contrast to FIG. 5, however, tool path points 80 are formed on the cross-sectional path 54. At the tool path points 80, a tool path to be generated and not yet illustrated intersects the cross-sectional path 54. More precisely, a tool path section of the tool path not illustrated revolves around the rotation axis R between adjacent tool path points 80.

The tool path points 80 are distributed along the cross-sectional path 54. The tool path points 80 may be distributed evenly along the cross-sectional path 54 as illustrated. When determining tool path points 80 on the cross-sectional path 54, taking into account manufacturing parameters may be an advantage. Manufacturing parameters may also include the width and/or height of a material applied. In particular, the tool path points 80 may be distributed evenly along the cross-sectional path 54 if the width and height of the material applied are identical. In the present case, the tool path points 80 are arranged along the cross-sectional path 54 at a fixed distance L.

Starting from the starting point 78, this point may represent a first tool path point 80. Starting from the starting point 78, further tool path points 80 may be generated along the cross-sectional path 54 until the end point 79 is reached.

FIG. 7 shows the cross-sectional contour 42 with a continuous cross-sectional path 54 including an example of a tool path 82. A first tool path section 84 of the tool path 82 extends between two adjacent tool path points 80 of the cross-sectional path 54 and revolves around the rotation axis R.

It can be seen that the tool path 82 intersects the cross-sectional path 54 or the surface surrounded by the cross-sectional contour 42 at the tool path points 80. The tool path 82 may be the tool path 20 of FIG. 1.

FIG. 8 shows the tool path 82 in connection with the continuous cross-sectional path 54. FIG. 8 in particular shows how the tool path 82 or the tool path section 84 is generated using the cross-sectional path 54.

Starting from a first tool path point 81, in the present case the lower of the two tool path points, position information is continuously taken into account until an adjacent, second tool path point 83, in the present case the upper of the adjacent tool path points, is reached. More precisely, position information of individual points on the cross-sectional path 54 between the adjacent tool path points 81, 83 is continuously assigned to individual points of the tool path section 84. In other words, points on the tool path section 84 are generated based on points on the cross-sectional path 54. The position information includes a height coordinate z and a distance coordinate r. The position information further includes angle information α. The angle information α may be formed for a point on the tool path section 84 by determining how far away a point on the cross-sectional path 54 is from the first tool path point 81 on the cross-sectional path 54 and how close it is to the second tool path point 83. Proportionally, the angle information α is formed as a proportion of a complete revolution about the rotation axis R.

FIG. 8 shows an example of a point 86 on the cross-sectional path 54 in the cross-sectional contour 42. The point 86 is on a portion of the cross-sectional path or a cross-sectional path section. Based on the point 86 of the cross-sectional path 54, a point 88 of the tool path section 84 is generated. For this purpose, the point 88 of the tool path section 84 is assigned the height coordinate z and the distance coordinate r of the point 86 of the cross-sectional path 54. The distance coordinate r describes a perpendicular distance of the point 86 relative to the rotation axis R. The height coordinate z describes a height in the direction of the rotation axis R. Furthermore, it is determined for the point 86 on the cross-sectional path 54 how far away it is from the first tool path point 81 on the cross-sectional path 54. This distance is set in relation to the distance between the two adjacent tool path points 81, 83 on the cross-sectional path 54. Proportionally, the angle information α is determined as a proportion of a complete revolution about the rotation axis R. The angle information α, too, is assigned to the point 88 of the tool path section 84.

Based on the described procedure for generating the tool path 82, it can be seen that starting from the first tool path point 81, the tool path section 84 is initially configured to combine a spiral shape and a helical shape. This is due to the fact that the first tool path point is formed on a connecting path between parallel paths of the cross-sectional path 54 and that this connecting path is arranged at an angle relative to the rotation axis R. When a corner point 90 is reached on the cross-sectional path 54 between the connecting path and the parallel path, the tool path section 84 is configured to have a spiral shape until the second tool path point 83 is reached. This is due to the fact that the cross-sectional path 54 between the corner point 90 and the second tool path point 83 is configured perpendicularly relative to the rotation axis R. This means that the tool path section 84 has a kink in its pitch.

FIG. 9 is an alternative view to that of FIG. 8. More specifically, FIG. 9 is a slightly tilted view of the cross-sectional contour 42.

FIG. 9 also shows the tool path 82 in connection with the continuous cross-sectional path 54. It can be seen that the tool path section 84 intersects the cross-sectional path 54 and thus the surface surrounded by the cross-sectional contour 42 at the first tool path point 81. Further, the tool path section 84 revolves about the rotation axis R (not illustrated) and intersects the cross-sectional path 54 or the surface surrounded by the cross-sectional contour 42 at the second tool path point 83. Further, the point 86 is shown on the cross-sectional path 54, which is disposed between the first tool path point 81 and the second tool path point 83 on the cross-sectional path 54. In addition, the corresponding point 88 on the tool path section 84, which was generated based on the point 86 on the cross-sectional path 54, is illustrated.

The point 86 on the cross-sectional path 54 is assigned the height coordinate z, the distance coordinate r and the angle information 0. The point 88 of the tool path section 84 is assigned the height coordinate z, the distance coordinate r and the angle information α. It could be said that the two points 86, 88 correspond to each other but that the point 86 of the cross-sectional path 54 is rotated around the rotation axis R using the angle information α to generate the point 88 of the tool path section 84.

FIG. 10 is a further alternative view of the tool path 82 in connection with the continuous cross-sectional path 54. Compared to FIG. 9, however, the entire tool path section 84 is shown. It can be seen that the tool path section 84, starting from the first tool path point 81, rotates completely around the rotation axis R until the second tool path point 83 is reached. In addition, the cross-sectional contour 42 is shown at least in sections.

FIG. 11 shows a section of the cross-sectional contour 42 including a continuous cross-sectional path 54. Other than in the previous illustrations, neither the tool path 82 nor the tool path section 84 is shown. The first tool path point 81 and the second tool path point 83 are shown on the cross-sectional path 54. Between the two tool path points 81, 83, there is the point 86 on cross-sectional path 54. The point 86 on the cross-sectional path 54 is assigned the height coordinate z, the distance coordinate r and the angle information 0.

FIG. 12 is another view of the tool path 82. Compared to the previous illustrations of the tool path 82, the first tool path section 84 is shown together with a second tool path section 92. The second tool path section 92 adjoins the first tool path section 82 and is further connected to the latter by the second tool path point 83. Further, the second tool path section 92 intersects the cross-sectional path 54 at a third tool path point 94.

FIG. 12 also shows the rotation axis R about which the first tool path section 84 and the second tool path section 92 revolve. Furthermore, the cross-sectional contour 42 is shown almost completely.

FIG. 13 in an alternative view of the tool path 82 of FIG. 12. More specifically, FIG. 13 is a tilted view of the cross-sectional contour 42. The first tool path section 84, starting from the first tool path point 81, revolves around the rotation axis R (not illustrated) and intersects the cross-sectional path 54 at the second tool path point 83. Furthermore, the second tool path section 92 is connected to the first tool path section 84 by the second tool path point 83. The second tool path section 92, starting from the second tool path point 83, revolves around the rotation axis R (not illustrated) to the third tool path point 94.

The cross-sectional path 54 is disposed between the second tool path point 83 and the third tool path point 94 substantially perpendicularly relative to the rotation axis R. Accordingly, the second tool path section 92 has a spiral shape.

From FIGS. 12 and 13 it can be seen that tool path sections 84, 92 can be easily formed starting from the cross-sectional path 54 and the tool path points 81, 83, 94. The more tool path sections are formed for adjacent tool path points, the more completely the tool path 82 is described.

FIG. 14 is a view of an additionally extended tool path 82. Compared to the illustrations of the first tool path section 84 and the second tool path section 92 in FIGS. 12 and 13, another four tool path sections 96 are shown, each disposed between adjacent tool path points 80.

For reasons of clarity, only a selection of tool path sections 84, 92, 96 are shown. However, the tool path sections 84, 92, 96 may be formed for the entire cross-sectional path 54 so that a complete tool path 82 can be provided for the cross-sectional contour 42.

FIG. 15 is a perspective side view of an alternative workpiece 328 to be manufactured. The workpiece 328 is rotationally symmetric about the symmetry axis A. Upon close scrutiny, it can be seen that the alternative workpiece 328 is based on the workpiece 28 of FIG. 2. For example, the workpiece 328 is formed to be hollow on the inside and includes the inner shoulder 336. Further, an inner surface 340 (not shown in detail in the illustration) is formed below the shoulder 336.

In addition, the workpiece 328 includes a plate-shaped collar 397. The collar 397 is formed on the frustoconical lateral surface 330 that is connected to the cylindrical lateral surface 332 at a lower end of the workpiece 328 by the transitional lateral surface 334. Starting from the frustoconical lateral surface 330, the plate-shaped collar 397 is disposed substantially perpendicularly relative to the symmetry axis A, i.e. in a radial direction. The plate-shaped collar 397 further has an upper plate surface 398 and a lower plate surface 399 that are parallel to each other. The plate-shaped collar 397 thus has a constant collar thickness.

FIG. 16 shows an example of a cross-sectional contour 342 of the alternative workpiece 328 to be manufactured including the rotation axis R. The rotation axis R corresponds to the symmetry axis A of FIG. 15. Like the cross-sectional contour 42 of FIG. 4, the cross-sectional contour 342 of the alternative workpiece 328 to be manufactured is a closed contour line.

The cross-sectional contour 342 is based on the alternative rotationally symmetric workpiece 328 and is two-dimensional. The cross-sectional contour 342 may be generated in a manner that is analogous to the cross-sectional contour 42 of FIG. 4. In particular, the cross-sectional contour 342 may be generated by intersecting the workpiece 328 with a plane in which the symmetry axis A is. Intersecting the workpiece 328 in this manner creates two cross-sectional half contours that are separated by the workpiece axis A and the rotation axis R, respectively, with the cross-sectional contour 342 being one of the two cross-sectional half contours. The cross-sectional contour 342 is spaced apart from the rotation axis R, the arrangement of the cross-sectional contour 342 relative to the rotation axis R resulting from the rotationally symmetric workpiece 328 and the previously explained generation of the cross-sectional contour 342.

The cross-sectional contour 342 includes an upper oblique contour line 344 and a lower oblique contour line 345, with a plate contour 347 formed between the two that is based on the plate-shaped collar 397. The plate contour 347 includes an upper plate contour line 349 and a lower plate contour line 351 that are connected by a lateral plate contour line 353.

The cross-sectional contour 342 further includes a perpendicular contour line 346 based on the cylindrical lateral surface 332. The lower oblique contour line 345 and the perpendicular contour line 346 are connected by an arcuate contour line 348 based on the transitional lateral surface 334. The cross-sectional contour 342 further includes an inner contour line 350 based on the inner surface 340. In addition, a shoulder contour line 352 is formed based on the shoulder 336.

It can be seen that the cross-sectional contour 342 together with the rotation axis R describes the rotationally symmetric workpiece 328. A contour of the rotationally symmetric workpiece 328 may be generated by rotating the cross-sectional contour 342 about the rotation axis R. In the process, the cross-sectional contour 342 performs a 360° rotation about the rotation axis R.

Looking at the cross-sectional contour 342, varying wall thicknesses of the workpiece 328 can be seen. It can further be seen that the plate contour 347 is substantially perpendicular or extends in a radial direction relative to the rotation axis R.

FIG. 17 shows the cross-sectional contour 342 of the alternative workpiece 328 to be manufactured of FIG. 16, having a first continuous cross-sectional path 354 and a second continuous cross-sectional path 355. The first continuous cross-sectional path 354 is formed analogously to the continuous cross-sectional path 54 of FIG. 5 and is inscribed in a portion of the cross-sectional contour 342 based on the cross-sectional contour 42 of FIG. 5. With respect to forming the first continuous cross-sectional path 354 and with respect to general aspects of forming a continuous cross-sectional path, reference is made to the continuous cross-sectional path 54 of FIG. 5.

The second continuous cross-sectional path 355 is inscribed in a portion of the cross-sectional contour 342 based on the plate contour 347. Starting from a left end 357 of the plate contour 347, the second continuous cross-sectional path 355 extends to the lateral plate contour line 353. The second continuous cross-sectional path 355 is formed as parallel paths, wherein adjacent parallel paths are connected to each other by a connecting path.

It can be seen that the parallel paths depend on a wall thickness of the portion of the cross-sectional contour 342, the wall thickness resulting from a distance between the upper plate contour line 349 and the lower plate contour line 351. The greater the wall thickness of the portion of the cross-sectional contour 342, in the present case the plate contour 347, the longer the parallel paths. For example, the parallel paths are longer at the left end 357 where the wall thickness of the plate contour 347 is greater.

It should be noted that the second cross-sectional path 355 is an example of how the second cross-sectional path 355 may be disposed within the cross-sectional contour 42. However, it is essential that the second cross-sectional path 355 also has a defined starting point 378 and a defined end point 379 that are disposed on the outside of the cross-sectional contour 342 or the outside of a portion of the cross-sectional contour 342, such as the plate contour 347 in the present case, if the cross-sectional contour 342 is divided into several portions. The second cross-sectional path 355 may also be formed between the defined starting point 378 and the defined end point 379 in different ways.

Furthermore, the second cross-sectional path 355 is also inscribed in the cross-sectional contour 342 in such a way that material application along a tool path to be generated from the second cross-sectional path 355 is sufficient to fill the portion of the cross-sectional contour 342, in the present case the plate contour 347. In this context, it may be an advantage to take manufacturing parameters into account already when generating the second continuous cross-sectional path 355. The manufacturing parameters may include a width and a height of the material applied.

According to a simplified procedure, it can be assumed that material is applied along the second cross-sectional path 355. The second cross-sectional path 355 is to be inscribed in the portion of the cross-sectional contour 342 in such a way that the material applied completely fills the portion of the cross-sectional contour 342, i.e. the plate contour 347.

Dividing the cross-sectional contour 342 into portions is a particular advantage if the cross-sectional contour 342 is complex. As a result of a complex cross-sectional contour 342, manufacturing using a tool path may not be possible or may at least involve an increased effort. If, for example, the parallel paths of the first cross-sectional path 354 were to extend into the plate contour 347, at least the lowest parallel path would initially have no path below it to build upon unless the rotation axis is tilted. However, this would complicate the manufacturing process. Dividing into several portions may thus improve the application or manufacturing process. The application or manufacturing process may be customized for the individual portions. In particular, cross-sectional path shapes, width and/or height of the material applied, substance and/or alignment information may be selected individually for portions. Complex manufacturing processes can thus be avoided, for example, by appropriately selecting portions of the cross-sectional contour 342. In the present case, a second cross-sectional path 355 laterally adjoining the first cross-sectional path 354 or the first portion of the cross-sectional contour 342 and manufacturing the workpiece first using a tool path based on the first cross-sectional path 354 and then using a tool path based on the second cross-sectional path 355 may help to avoid complicated manufacturing. For the second cross-sectional path 355, alignment information is then to be selected, e.g. an alignment perpendicular to the rotation axis R.

FIG. 18 shows a section of a cross-sectional contour 442 similar to that of FIG. 6, but tool path points are determined differently. A first distance L1 and a second distance L2 are used to arrange tool path points on differently aligned parts of the cross-sectional path 454 or path sections of different pitch relative to the rotation axis R. In the present case, the first distance L1 is used to arrange tool path points along a first path section, i.e. a horizontal path section, on the cross-sectional path 454. The second distance L2 is used to arrange tool path points along a second path section, i.e. a connecting path. A combination of the two distances L1 and L2 is used to determine the tool path points at transitions in the cross-sectional path 454.

For example, a first tool path point 481 is spaced from a second tool path point 483 by distance L1. Both tool path points 481, 483 are arranged on a first path 466, wherein the first path 466 is one of the parallel paths and runs straight.

A third tool path point 494 is arranged on a first connecting path 470. Between the second tool path point 483 and the third tool path point 494 there is a transition with a corner point 490. Starting from the second tool path point 483, the first distance L1 is at least partially used for the first path 466 until it finally merges into the first connecting path 470. If only a percentage of the first distance L1 is used, a percentage of the second distance L2 is determined for the immediately following cross-sectional path 454 in proportion to the remaining percentage.

The respective distance L1, L2 may determine the extent to which the angle information α progresses. The distances L1, L2 may thus have an impact on the tool path points on the cross-sectional path 454 and the course of the tool path. In the present case, the chosen second distance L2 is smaller than the first distance L1. This means that the second distance L2 causes the angle information α to progress more strongly relative to the cross-sectional path. In other words, in the case of the smaller second distance L2, the tool path rotates about the rotation axis R within a smaller part of the cross-sectional path.

The distances L1 and L2 may be determined based on manufacturing parameters such as a height and width of a material applied. In the present case, the first distance L1 is based on a width of the material applied. In the present case, the second distance L2 is based on a height of the material applied or a combination of a height and width of the material applied.

In addition to the tool path points 481, 483, 494, other tool path points along the cross-sectional path may be determined in this manner. It should be noted that in addition to distance L or distances L1, L2, there may be any number of distances which are preferably provided for portions of the cross-sectional path 454 of different orientation.

FIG. 19 shows a section of a cross-sectional contour 542 having a continuous cross-sectional path 554, wherein alignment information is provided for some points on the cross-sectional path 554. The alignment information describes an alignment of a tool axis of the application tool 12. Preferably, the tool axis is the axis along which the laser 22 is directed. In the present case, the alignment information is a direction vector that is oriented in the direction of the application tool 12. However, the alignment information may also be an alignment angle indicating the angle of the tool axis relative to the rotation axis R.

The points on the cross-sectional path 554 may be any points. However, the points on the cross-sectional path may also be tool path points. Alternatively, the alignment information may also be provided for points on the tool path.

In the present case, a first direction vector 502 is provided at a first point 501 of the cross-sectional path 554. Further, a second direction vector 504 is provided at a second point 503 of the cross-sectional path 554, a third direction vector 506 is provided at a third point 505, a fourth direction vector 508 is provided at a fourth point 507, and a fifth direction vector 510 is provided at a fifth point 509.

It can be seen that the direction vectors 502, 504, 506, 508, 510 are not uniformly oriented. The first direction vector 502, third direction vector 506 and fifth direction vector 510 are oriented substantially the same in the upward direction, but they are slightly tilted. Depending on the cross-sectional contour 542 or the workpiece, the direction vectors 502, 506, 510 may also be oriented differently. The second direction vector 504 and the fourth direction vector 508, too, are oriented substantially the same, but they are substantially parallel to the inner contour line 550. Depending on the cross-sectional contour 542 or the workpiece, the direction vectors 504, 508 may also be oriented differently.

The alignment information may be derived from a local shape of the workpiece to be manufactured. The alignment information may further be used to align the tool axis of the application tool 12 in such a way that the material to be applied is applied to material that has already been applied. This is necessary because in additive manufacturing the material requires a substrate that supports the new material to be applied.

FIG. 20 shows the section of the cross-sectional contour 542 of FIG. 19, but the available alignment information has been expanded. More precisely, alignment information was determined for each exemplary point between the points having alignment information.

For example, the first direction vector 502 and the second direction vector 504 were used to determine direction vectors for points between the first point 501 and the second point 503 along the cross-sectional path 554. More specifically, the alignment information for these points is averaged based on the direction vectors 502, 504. For example, the farther such a point is located from the first point 501 toward the second point 503 along the cross-sectional path, the more similar the determined direction vector is to the second direction vector 504. Averaging may be performed on the basis of interpolation or linear interpolation.

FIG. 21 shows a section of the cross-sectional contour 542 of FIGS. 19 and 20. It is an example of how available alignment information is used to determine alignment information for a point 511 on the cross-sectional path 554.

Initially, the first direction vector 502 is present at the first point 501 and the second direction vector 504 is present at the second point 503. These direction vectors are shown in bold to stand out from determined direction vectors. A first tool path point 581 and a second tool path point 583 are located on the cross-sectional path 554 between the two points 501, 503. However, they are for illustrative purposes only and are not used for determining alignment information in this example. Nevertheless, alignment information could also be determined for them.

Between the two points 501, 503, the point 511 is disposed on the cross-sectional path 554. It is described by the height coordinate z and the distance coordinate r. Since the point 511 is disposed on the cross-sectional path 554, the angle information 0 (“zero”) is assigned to it. In this context, reference is made to FIG. 11. In this Figure, for example, point 511 is shown as point 86, but without alignment information. Depending on the distance of the point 511 to the first point 501 and the second point 503 on the cross-sectional path 554, the direction vectors 502, 504 are averaged, in particular linearly interpolated, in order to determine alignment information in the form of a direction vector 512 for the point 511.

FIG. 22 shows the cross-sectional contour 42 with a continuous cross-sectional path 54 including an exemplary first tool path section 84 of the tool path 82. FIG. 22 is based on FIG. 7 but provides a more comprehensive overview. It illustrates the rotation axis R about which the tool path section 84 rotates, for example. It also shows a point 85 on the tool path 82 that is rotated about the rotation axis R relative to the cross-sectional contour 42 by an angle α. Alignment information is provided for the point 85 on the tool path 82 in the form of a direction vector 87. The direction vector 87 is aligned along a tool axis W. The tool axis W intersects the rotation axis R at the axis intersection point 89. An application tool head 14 of the application tool 12 (not shown in more detail) is shown schematically at the point 85. This is to illustrate that the application tool 12 applies material along the tool path 82. Since the application tool head 14 is oriented along the tool axis W, the alignment information for point 85 is taken into account.

The tool path section 84 extends between the first tool path point 81 and the second tool path point 83. Individual points on the tool path section 84 were determined based on the cross-sectional path 54 between the first and second tool path points 81, 83. For example, as described previously, the distance coordinate r and the height coordinate z of a point on the cross-sectional path 54 between the tool path points 81, 83 were taken for the point 85. Furthermore, an angle information α was determined based on the position of the point on the cross-sectional path 54 with respect to the tool path points 81, 83 along the cross-sectional path 54. The alignment information for point 85 was either taken from the point on the cross-sectional path 54, provided alignment information was available for it. Alternatively, the alignment information was determined based on specified alignment information, as described above. In this case, it may be provided that the alignment information of the point on the cross-sectional path, in particular if it is available as a vector, is rotated about the rotation axis R to the point 85 of the tool path 84 using the angular information α. Again, alternatively, the alignment information for the point 85 was specified. For different points of the tool path 84, various of the previously explained procedures for determining the alignment information may be applied.

In analogy to the described procedure, starting from the cross-sectional path 54 in the cross-sectional contour 42 or the portion of the cross-sectional contour 42, arbitrary points of the tool path 82 may be generated to completely describe the tool path 82 and to enable additive manufacturing.

Preferably, the tool axis W intersects the rotation axis R. This is the case when the tool axis W is not aligned parallel to the rotation axis R.

In addition to the foregoing, according to further embodiments of the invention, it may be provided that at least one of the following manufacturing parameters is changed during additive manufacturing of the workpiece:
Composition of the additive manufacturing material,
Feed rate of the application tool,
Power of the application tool, and
Gas flow of the application tool.

For example, with reference to the illustration shown in FIG. 9, the powder composition may be changed at a particular point, for example at the point 81, in combination with the power of the application laser relative to the remaining path 84. The transitions may be abrupt or linearly interpolated.

1. A method for generating a tool path (20; 82) for an application tool (12) for additive manufacturing, in particular for additive manufacturing using buildup welding, of a substantially rotationally symmetric workpiece (28; 328), comprising the following steps:
a) providing cross-sectional contour data describing at least a portion of a cross-sectional contour (42; 342; 442; 542) of the workpiece (28; 328);
b) providing axis data describing a rotation axis (R) of the rotationally symmetric workpiece (28; 328);
c) generating a continuous cross-sectional path (54; 354; 355; 454; 554), taking into account the cross-sectional contour data, the cross-sectional path (54; 354; 355; 454; 554) being inscribed in the portion of the cross-sectional contour (42; 342; 442; 542);
d) generating the tool path (20; 82) with a helical or/and spiral course revolving around the rotation axis (R), wherein the tool path (20; 82) intersects the cross-sectional path (54; 354; 355; 454; 554), preferably with each revolution around the rotation axis (R).

2. The method of claim 1, characterized in that step d) comprises the sub-steps of:
d1) determining tool path points (80; 81; 83; 94; 481; 483; 494; 581; 583) on the cross-sectional path (54; 354; 355; 454; 554), taking into account at least one manufacturing parameter; and
d2) generating the tool path (20; 82) from tool path sections (84, 92, 96), wherein each tool path section (84, 92, 96) rotates completely about the rotation axis (R) and connects two adjacent tool path points (80; 81; 83; 94; 481; 483; 494; 581; 583) on the cross-sectional path (54; 354; 355; 454; 554) to one another.

3. The method of claim 2, characterized in that at least a width or/and a height of a one-time material application of the application tool (12) is/are provided as manufacturing parameter(s).

4. The method of one of the preceding claims, characterized in that at least one manufacturing parameter is taken into account when generating the continuous cross-sectional path (54; 354; 355; 454; 554), at least a width or/and a height of a one-time material application of the application tool (12) being provided as manufacturing parameter(s).

5. The method of claim 4, characterized in that the cross-sectional path (54; 354; 355; 454; 554) is inscribed in the portion of the cross-sectional contour (42; 342; 442; 542) in such a way that, as a result of a continuous material application along the tool path (20; 82), taking into account the at least one manufacturing parameter, the portion of the cross-sectional contour (42; 342; 442; 542) is substantially completely filled with material.

6. The method of any one of claim 4 or 5, in particular insofar as dependent on claim 2, characterized in that the cross-sectional path (54; 354; 355; 454; 554) is formed to be meandering or/and run parallel at least in sections, in particular if the width of the material applied is smaller than a width of the portion of the cross-sectional contour (42; 342; 442; 542).

7. The method of any one of the preceding claims, characterized in that the cross-sectional path (54; 354; 355; 454; 554) comprises a starting point (78; 378) and an end point (79; 379) each located at an outer or inner edge of the portion.

8. The method of claim 2 and any of the preceding claims, wherein during the determining of the tool path points (80; 81; 83; 94; 481; 483; 494; 581; 583) on the cross-sectional path (54; 354; 355; 454; 554) a course of the cross-sectional path (54; 354; 355; 454; 554) with respect to the rotation axis (R) is taken into account.

9. The method of claim 2 and any one of the preceding claims, wherein the tool path points (80; 81; 83; 94; 481; 483; 494; 581; 583) are determined with a substantially constant distance (L) from each other or with at least a first and a second distance (L1, L2) on the cross-sectional path (54; 354; 355; 454; 554).

10. The method of any one of claim 2, 8 or 9, characterized in that each tool path section (84, 92, 96) between adjacent tool path points (80; 81; 83; 94; 481; 483; 494; 581; 583) of the cross-sectional path (54; 354; 355; 454; 554) is determined according to a course of the cross-sectional path section lying between these adjacent tool path points (80; 81; 83; 94; 481; 483; 494; 581; 583).

11. The method of claim 10, characterized in that the tool path section (84, 92, 96) is generated between the adjacent tool path points (80; 81; 83; 94; 481; 483; 494; 581; 583) by taking into account at least one item of position information starting from a first of the adjacent tool path points (80; 81; 83; 94; 481; 483; 494; 581; 583) until the second of the adjacent tool path points (80; 81; 83; 94; 481; 483; 494; 581; 583) is reached.

12. The method of claim 11, characterized in that the position information comprises:
a height coordinate (z) of a point (86; 511) on the cross-sectional path (54; 354; 355; 454; 554) or/and
a distance coordinate (r) of a point (86; 511) on the cross-sectional path (54; 354; 355; 454; 554) relative to the rotation axis (R) or/and
angle information (α) with respect to the first or/and the second tool path point (80; 81; 83; 94; 481; 483; 494; 581; 583).

13. The method of any one of the preceding claims, characterized by the step of providing alignment information for at least one point of the tool path (20; 82), preferably for at least one of the tool path points (80; 81; 83; 94; 481; 483; 494; 581; 583), said alignment information describing an alignment of a tool axis (W) of the application tool (12) in said point of the tool path (20; 82), specifically the tool path point (80; 81; 83; 94; 481; 483; 494; 581; 583).

14. The method of claim 13, characterized in that the alignment information for at least one further point of the tool path (20; 82), in particular another one of the tool path points (80; 81; 83; 94; 481; 483; 494; 581; 583), is determined, taking into account the alignment information for the at least one point of the tool path (20; 82), in particular the at least one of the tool path points (80; 81; 83; 94; 481; 483; 494; 581; 583).

15. The method of claim 14, wherein the alignment information is provided each for a first and a second point on the tool path (20; 82), preferably for a first and a second tool path point (80; 81; 83; 94; 481; 483; 494; 581; 583), and a continuous course is determined for points between the first and second point on the tool path (20; 82), preferably between the first and second tool path point (80; 81; 83; 94; 481; 483; 494; 581; 583), preferably using interpolation, particularly preferably using linear interpolation.

16. The method of any one of claims 1 to 15, characterized in that
(i) a first item of alignment information is provided for at least one point (501; 503; 505; 507; 509) on the cross-sectional path (54; 354; 355; 454; 554) and
(ii) based on the first item of alignment information, a second item of alignment information is provided for at least one point of the tool path (20; 82), preferably for at least one of the tool path points (80; 81; 83; 94; 481; 483; 494; 581; 583);
wherein each item of alignment information describes an alignment of a tool axis (W) of the application tool (12) for the respective point.

17. The method of claim 16, wherein the first item of alignment information is determined for at least one further point (86; 511) on the cross-sectional path (54; 354; 355; 454; 554), taking into account the first item of alignment information.

18. The method of claim 17, wherein the first item of alignment information is provided in step (i) each for a first and a second point (501; 503; 505; 507; 509) on the cross-sectional path (54; 354; 355; 454; 554) and a continuous course is determined for points (86; 511) between the first and second point (501; 503; 505; 507; 509) on the cross-sectional path (54; 354; 355; 454; 554) preferably using interpolation, particularly preferably using linear interpolation.

19. The method of any one of claims 13 to 18, characterized in that the alignment information describes an angle between the tool axis (W) and the rotation axis (R) or a direction vector (87; 502, 504, 506, 508, 510, 512) of the tool axis (W).

20. The method of any one of claims 13 to 19, characterized in that the alignment information of a point on the tool path (20; 82), preferably of a tool path point (80; 81; 83; 94; 481; 483; 494; 581; 583), or of a point (86; 511) of the cross-sectional path (54; 354; 355; 454; 554) is determined according to a course of the cross-sectional contour (42; 342; 442; 542).

21. The method of any one of the preceding claims, characterized in that the cross-sectional contour data or/and the axis data are determined from:
3D model data of the workpiece (28; 328) or
data of a preferably two-dimensional removal tool path for a removal tool of a cutting process for manufacturing the workpiece (28; 328), preferably of a machining process, particularly preferably of a turning or/and milling process.

22. A method for additive manufacturing of a workpiece (28; 328) using at least one tool path (20; 82) generated according to the method of any one of claims 1 to 21.

23. The method of claim 22, wherein at least one of the following manufacturing parameters is variable during additive manufacturing of the workpiece:
Composition of the additive manufacturing material (24),
Feed rate of the application tool (12),
Power of the application tool (12), and
Gas flow of the application tool (12).

24. The method of claim 23, wherein different parameter values are assigned to at least one of the manufacturing parameters at different points along the cross-sectional path or tool path (54; 354; 355; 454; 554).

25. The method of claim 24, wherein the parameter values of a particular manufacturing parameter in a section of the cross-sectional path or tool path between two successive points at which the manufacturing parameter has different parameter values is determined by interpolation, preferably linear interpolation.

26. The method of any one of claims 22 to 25, wherein moving along the tool path (20; 82) is performed at a substantially constant feed rate for the application tool (12).

27. The method of any one of claims 22 to 26, wherein moving along the tool path (20; 82) is performed at a variable feed rate for the application tool (12).

28. The method of claim 27, wherein at least during a final tool revolution, the tool feed rate is increased or reduced relative to a non-final tool revolution.

29. An apparatus (10) for additive manufacturing of a substantially rotationally symmetric workpiece (28; 328) using a tool path (20; 82) generated according to the method of any one of claims 1 to 18;
wherein the apparatus (10) comprises an application tool (12) for additive manufacturing, in particular a buildup welding head;
wherein the apparatus (10) generates a continuous cross-sectional path (54; 354; 355; 454; 554) in accordance with cross-sectional contour data describing at least a portion of a cross-sectional contour (42; 342; 442; 542) of the workpiece (28; 328) and in accordance with axis data describing a rotation axis (R) of the rotationally symmetric workpiece (28; 328), taking into account the cross-sectional contour data;
wherein the cross-sectional path (54; 354; 355; 454; 554) is inscribed in the portion of the cross-sectional contour (42; 342; 442; 542);
wherein the apparatus (10) generates the tool path (20; 82) with a helical or/and spiral course revolving around the rotation axis (R);
wherein the tool path (20; 82) intersects the cross-sectional path (54; 354; 355; 454; 554), preferably with each revolution around the rotation axis (R); and
wherein the apparatus (10) guides the application tool (12) along the tool path (20; 82), thereby applying material.

30. The apparatus (10) of claim 29, the apparatus (10) further comprising a method of any one of the claims 22 to 28.
